(19) United States
(12) Patent Application Publication
(10) Pub. No.: US 2006/0064374 A1
(43) Pub. Date: Mar. 23, 2006

(54) Fraud risk advisor

(76) Inventors: David Helsper, Marietta, GA (US); Dennis Maicon, Alpharetta, GA (US)

Correspondence Address: NEEDLE & ROSENBERG, P.C., SUITE 1000, 999 PEACHTREE STREET, ATLANTA, GA, 30309-3915, US

(21) Appl. No.: 10/943,454

(22) Filed: Sep. 17, 2004

(51) Int. Cl. G06Q 40/00

(52) U.S. Cl. 705/39

(57) ABSTRACT

A fraudulent business transaction application (FBTA) for monitoring application based fraud. When a consumer supplies account access information in order to carry out an Internet business transaction, the FBTA uses an online fraud mitigation engine to detect phishing intrusions and identity theft. The FBTA uses the account access information, a rules based engine and a risk score database to determine the likelihood that the Internet business transaction is fraudulent and deserves further review by personnel.

### BACKGROUND OF THE INVENTION

1. Field Of The Invention

The present invention relates to a technique for detecting fraudulent online business transactions. The present invention provides a method, apparatus and program for operating a fraud engine that is capable of accepting an IP address and a number of factors from an end user in order to determine whether a business transaction is fraudulent.

2. Description of the Related Art

The ease of hiding an identity on the Internet makes it difficult for financial services organizations to carry the “know your customer” mantra to the online world. In 2003 alone, Internet-related fraud accounted for 55% of all fraud reports according to the Federal Trade Commission, up nearly 45% from the previous year. In order for financial services organizations to continue successfully serving more of their customers online, creating a safe and secure environment is a top priority. Accordingly, there is a need and desire for a method and apparatus for detecting and preventing fraudulent online business transactions.

### SUMMARY OF THE INVENTION

The present invention provides a method and apparatus for determining fraudulent online business transactions. In an exemplary embodiment, an end user inputs parameters and rules concerning a particular business transaction into the system. Based on the parameters, rules and other information concerning a particular transaction, the system computes a score associated with the likelihood that the transaction is fraudulent. The score is then compared with various thresholds set by the end user. If the score exceeds the thresholds set by the end user, then the transaction is determined to be fraudulent. Data regarding the transaction may also be output to the end user. Upon review, the end user may change the fraud status of a given transaction.

### BRIEF DESCRIPTION OF THE DRAWINGS

The foregoing and other advantages and features of the invention will become more apparent from the detailed description of exemplary embodiments of the invention given below with reference to the accompanying drawings.

FIG. 1 is a flow chart illustrating a method for determining whether an online business transaction is fraudulent in accordance with the present invention; and

FIG. 2 is a block diagram of a computer system for implementing the method of FIG. 1.

### DETAILED DESCRIPTION OF THE INVENTION

In the following detailed description, reference is made to the accompanying drawings, which form a part hereof, and in which is shown by way, of illustration of specific embodiments in which the invention may be practiced. These embodiments are described in sufficient detail to enable those skilled in the art to practice the invention, and it is to be understood that other embodiments may be utilized, and that structural, logical and programming changes may be made without departing from the spirit and scope of the present invention.

The term “risk factor” refers to any factor used in a business transaction that has some level of risk associated with it.

The term “static risk factor” refers to a factor that does not change at run time.

The term “dynamic risk factor” refers to a factor that has its value calculated at run time.

The term “risk value” refers to a number associated with a factor.

The term “risk weight” refers to a number that determines how much influence a factor's risk value is to the outcome of a risk score.

The term “rule” refers to a conditional statement that applies Boolean logic to risk values.

The term “risk score” refers to an aggregation of risk values based on a computation of risk values and risk weights or a rule setting the risk score directly.

The term “online fraud mitigation engine” (OFME) refers to a component of the present invention that accepts an IP address along with a number of factors to thereby create a risk score for a given transaction which can be used to determine if the transaction is suspicious and requires further review.

The term “transaction” refers to any type of online activity that requires authentication and could result in financial loss; for example, online banking account access, credit card transactions, online bill pay, wire transfers, stock trades and the like.

The term “transaction identifier” refers to a unique system generated number that identifies a particular risk score model.

The term “risk score model” refers to a set of logical rules, applicable static and dynamic factors, risk weights for the factors, a fraud score algorithm, a risk score threshold, and reason codes used to identify a suspicious transaction.

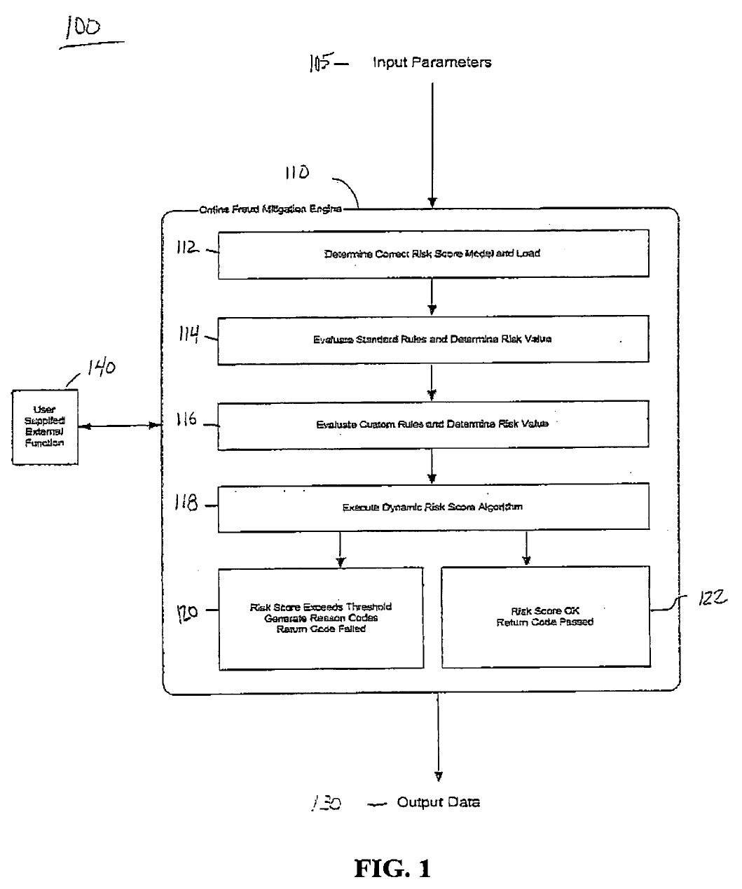

FIG. 1 is a flow chart illustrating steps for performing an online fraudulent business transaction determination in accordance with the present invention. At step 105, input parameters are input into the OFME by an end user, for example, a banking institution. The OFME provides a run-time environment for the selected risk score model. The OFME provides a rules based engine for receiving input parameters; for example, a transaction identifier, an IP address, a date/time stamp, a unique identifier and a number of static factors for processing. The OFME subsequently retrieves relevant information regarding an Internet user's IP address; for example, the Internet user's location, from a NetAcuity server. The operation of the NetAcuity server is discussed in U.S. patent application Ser. No. 09/832,959, which is commonly assigned to the assignee of the present application, which is herein incorporated by reference in its entirety.

A transaction identifier, which is unique, associated with a given Internet based transaction is used by OFME to determine which risk score model should be utilized for a given transaction. The Fraud Risk Advisor uses the unique identifier for tracking purposes. The results are then stored in a database.

Additional input parameters may be input into the OFME through end user supplied data. For example, the end user may utilize a hot file, suspect IP list, etc., which would be used by the OFME in the determination process. Once the OFME receives the specified input parameters, the Fraud Risk Advisor proceeds to step 112. In step 112, the end user will select from a set of standard risk score models or end user defined risk score models to be used for a particular determination.

After the OFME loads the appropriate risk score model, the present invention proceeds to step 114 in which the OFME evaluates a given set of factors and determines a risk value for each given factor. Once the risk value has been determined for each factor associated with the OFME, the present invention proceeds to step 116 in which the OFME evaluates a given set of rules and determines a risk score.

When the risk score has been determined by a rule match, the present invention proceeds to step 118 in which the OFME executes a risk score algorithm to determine an aggregate risk score. The OFME uses the standard risk value from the rules evaluation, as well as an optional static risk score to determine an aggregate risk score. For example, the rules based risk score could be assigned a value between 0 to 1,000. A risk score of 0 would be assigned to a transaction perceived to be highly fraudulent, while a risk score of 1,000 would be assigned to scores perceived to have a low risk of fraud.

Dependent on the risk score calculated in step 118 and threshold limits defined by an end user, the OFME determines whether the transaction proceeds to step 120 or step 122. If the score exceeds the predefined threshold level, the OFME proceeds to step 120 because the transaction is determined to be suspicious. Accordingly, the transaction is flagged and forwarded to the end user for further review along with each factor value and a reason code for each factor value. If the score is within predetermined threshold limits, the OFME proceeds to step 122 because the transaction is determined to be valid.

At step 130, the end user receives output from the OFME for the pending transaction. If the transaction is determined to be suspect by the OFME, the end user receives the results from the OFME including factor values and reason codes for the transaction. In addition, the OFME will update the present invention's real-time statistics and store all relevant data, for example, the IP address, regarding the transaction in a database, even if the transaction is deemed valid. The stored data is used for both reporting purposes as well as analysis purposes for updating the risk score model's risk weights or removing certain factors or rules. The end user has the ability to override the results of the OFME and may flag a transaction determined to be valid as suspicious or deem a suspicious transaction valid.

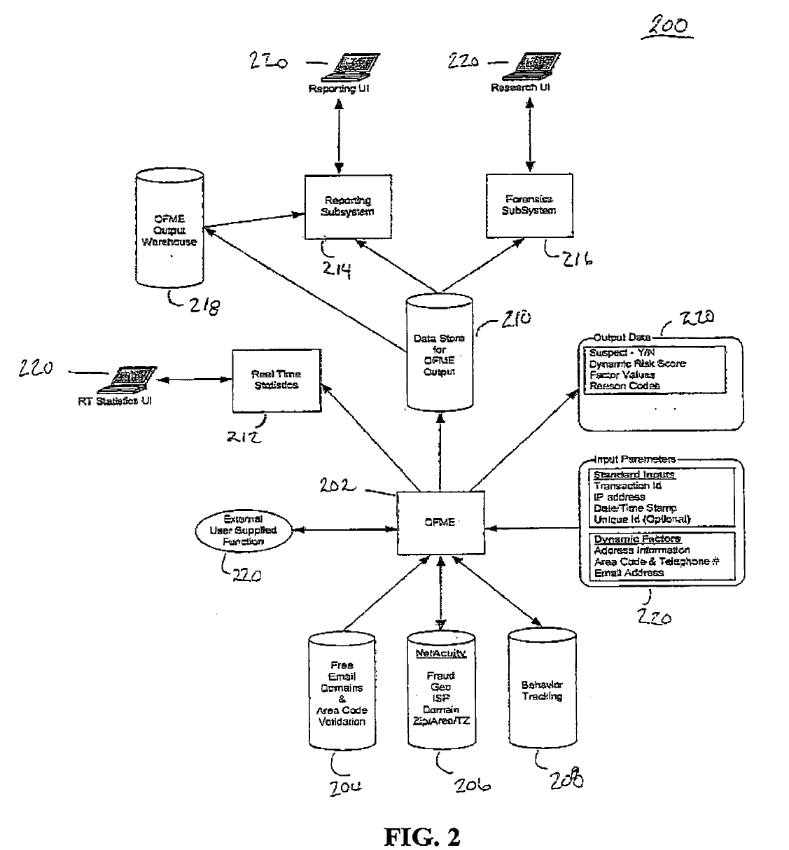

FIG. 2 illustrates is an exemplary processing system 200 with which the invention may be used. System 200 includes a user interface 220 in which an end user may input parameters, rules and user defined functions to the OFME 202. User interface 220 may comprise multiple user interfaces. The user interface 220 also receives output data from the OFME 202 regarding a certain transaction. The user interface 220 may be graphical or web based, or may use any other suitable input mechanism.

Once the OFME 202 receives data from the user interface 220, the OFME 202 acquires information associated with this data from, for example, a NetAcuity server 206, a validation server 204 and a behavior-tracking database 208. Validation server 204 validates email addresses and area codes supplied by the end user for a given transaction.

Behavior tracking database 208 uses a unique identifier supplied by the end user associated with a given Internet user to determine whether a current Internet based transaction is in congruence with the normal behavior of the Internet user. This unique identifier is stored in the searchable behavior-tracking database 208. When the Internet user performs an Internet based transaction, the behavior-tracking database 208 is searched and geographic data along with an ISP and domain, which may also be stored with the unique identifier, is retrieved, if available. This information is then compared to the geographic data, ISP and domain information associated with a current IP address for the current pending Internet based transaction. The result of the comparison, an access behavior factor, is used to determine whether the current pending Internet based transaction is fraudulent. If an access behavior violation is determined, an automated challenge/response could be used to validate the Internet user accessing an account in real time. If there is no history for the current IP address available in the behavior-tracking database 208 for the Internet user, the current geographic data, ISP and domain information associated with the current IP address is added to the behavior-tracking database 208. Accordingly, when an Internet user is creating an account, access behavior would not be used as a factor for fraud detection.

The unique identifier assigned to the Internet user may store multiple access behaviors. In addition, because an Internet user may change their access behavior due to, for example, extended travel, change of residence, etc., the end user may override an access behavior violation returned by the OFME 202.

The OFME 202 uses the information supplied by the user interface 220, NetAcuity server 206, validation server 204 and behavior-tracking database 208 to determine a risk score associated with a given transaction. Once the OFME 202 computes the risk score, the risk score is sent along with any relevant information concerning the transaction to behavior tracking database 208, real time statistics database 212, user interface 220 and OFME data storage database 210.

In one embodiment, OFME data storage database 210 may transfer data received from OFME 202 to OFME output warehouse storage 218 for long-term storage. In addition, OFME data storage database 210 may transfer data received from OFME 202 to both a Reporting subsystem 214 and a Forensics subsystem 216 for processing and output to the user interface 220. Forensics subsystem 216 provides the end user the ability to look-up information generated by running a risk score model. Thus, the end user can determine why a transaction is deemed suspicious or why a transaction was not deemed suspicious. Reporting subsystem 214 provides various reports to the end user, for example, the number of transaction flagged as being suspicious.

While the invention has been described in detail in connection with exemplary embodiments, it should be understood that the invention is not limited to the above-disclosed embodiments. Rather, the invention can be modified to incorporate any number of variations, alternations, substitutions, or equivalent arrangements not heretofore described, but which are commensurate with the spirit and scope of the invention. In particular, the specific embodiments of the Fraud Risk Advisor described should be taken as exemplary and not limiting. For example, the present invention may be used in a web-based application. Accordingly, the invention is not limited by the foregoing description or drawings, but is only limited by the scope of the appended claims.

We claim:

1. A method of determining a fraudulent business transaction comprising:
receiving an IP address associated with an Internet user;
computing a plurality of factors based on the IP address associated with a business transaction conducted by the Internet user; and
determining based on the IP address and the computation whether the business transaction is suspicious.

2. The method of claim 1 further comprising forwarding the determination to a client for further processing by the client.

3. The method of claim 1 further comprising generating a report based on the determination.

4. The method of claim 1 further comprising generating a risk score associated with the business transaction.

5. The method of claim 4 further comprising storing the risk score in a database.

6. The method of claim 4, wherein a client assigns a threshold level for comparison with the risk score.

7. The method of claim 6, wherein the transaction is determined to be fraudulent when the risk score exceeds the threshold level.

8. The method of claim 4, wherein the risk score is generated in real time.

9. The method of claim 1 further comprising accessing the determination by a client.

10. The method of claim 9, wherein the client may override the determination that the business transaction is suspicious.

11. The method of claim 9, wherein the client may designate a business transaction not determined to be suspicious as a suspicious business transaction.

12. The method of claim 1, wherein the plurality of factors are static or dynamic.

13. The method of claim 12, wherein the static factors comprise a country, region or city associated with the IP address.

14. The method of claim 12, wherein a dynamic factor is a proximity of the Internet user in comparison to a purported location of the Internet user associated with the IP address.

15. The method of claim 12, wherein a static factor is an address supplied by a client for comparison with the address associated with the IP address.

16. The method of claim 12, wherein a static factor is an area code and telephone number supplied by a client for comparison with an area code and telephone number stored in a database that is associated with the Internet user.

17. The method of claim 12, wherein a static factor is an email address supplied by a client for validation.

18. The method of claim 12, wherein a dynamic factor is an access behavior associated with the Internet user based on business transactions habits stored in a database that are compared with the business transaction.

19. The method of claim 12, wherein a dynamic factor is a frequency in which the business transaction is attempted within a predetermined period of time.

20. The method of claim 12, wherein a client may assign a threshold level for the static and dynamic factors.

21. The method of claim 12, wherein a client may create user defined dynamic factors.

22. The method of claim 12, wherein a dynamic factor is determined by a static factor.

23. The method of claim 1, wherein a client may define constraint rules for the factors.

24. A computer based medium, comprising: an application being executable by a computer, wherein the computer executes the steps of:
receiving an IP address associated with an Internet user;
computing a plurality of factors based on the IP address associated with a business transaction conducted by the Internet user; and
determining based on the IP address and the computation whether the business transaction is suspicious.

25. The computer based medium of claim 24, wherein the computer further executes forwarding the determination to a client for further processing by a client.

26. The computer based medium of claim 24, wherein the computer further executes generating a report based on the determination.

27. The computer based medium of claim 24, wherein the computer further executes generating a risk score associated with the business transaction.

28. The computer based medium of claim 27, wherein the computer stores the risk score in a database.

29. The computer based medium of claim 27, wherein a client assigns a threshold level for comparison with the risk score.

30. The computer based medium of claim 29, wherein the transaction is determined to be fraudulent when the risk score exceeds the threshold level.

31. The computer based medium of claim 27, wherein the risk score is generated in real time.

32. The computer based medium of claim 24, wherein a factor is an access behavior associated with the Internet user based on business transaction access habits stored in a database that are compared with the business transaction.

33. The computer based medium of claim 24 further comprising accessing the application by a client.

34. The computer based medium of claim 33, wherein the client may override the determination that the business transaction is suspicious.

35. The computer based medium of claim 33, wherein the client may designate a business transaction not determined to be suspicious as a suspicious business transaction.

36. The computer based medium of claim 24, wherein said application includes a web based application having a plurality of web pages and a plurality of databases.

37. An apparatus for detecting a fraudulent business transaction comprising:
a computer system including a processor for executing computer code; and
an application for execution on the computer system, wherein the computer system, when executing the application receives an IP address associated with an Internet user, computes a plurality of factors based on the IP address associated with a business transaction conducted by the Internet user and determines based on the IP address and the computation whether the business transaction is suspicious.

38. The apparatus of claim 37, wherein the application is a web based application.

39. The apparatus of claim 37, wherein the application has a client user interface.

40. The apparatus of claim 39, wherein the client may override the determination that the business transaction is suspicious.

41. The apparatus of claim 39, wherein the client may designate a business transaction not determined to be suspicious as a suspicious business transaction.

42. The apparatus of claim 37, wherein the application forwards the determination to a client for further processing by a client.

43. The apparatus of claim 37, wherein a factor is an access behavior associated with the Internet user based on business transaction access habits stored in a database that are compared with the business transaction.

44. The apparatus of claim 37, wherein the application generates a report based on the determination.

45. The apparatus of claim 37, wherein the application generates a risk score associated with the business transaction.

46. The apparatus of claim 45, wherein the application stores the risk score in a database.

47. The apparatus of claim 46, wherein the risk score is generated in real time.

48. The apparatus of claim 45, wherein a client assigns a threshold level for comparison with the risk score.

49. The apparatus of claim 48, wherein the transaction is determined to be fraudulent when the risk score exceeds the threshold level

50. The apparatus of claim 37, wherein said application includes a web based application having a plurality of web pages and a plurality of databases.

51. An apparatus for detecting a fraudulent business transaction comprising:
means for receiving an IP address associated with an Internet user;
means for computing a plurality of factors based on the IP address associated with a business transaction conducted by the Internet user; and
means for determining based on the IP address and the computation whether the business transaction is suspicious.
